(19) United States
(12) Patent Application Publication
(10) Pub. No.: US 2007/0286691 A1
(43) Pub. Date: Dec. 13, 2007

(54) CUTTING TOOL

(75) Inventors: Helmut Glimpel, Lauf (DE); Hans-Jorg Licha, Furth (DE)

Correspondence Address: WORKMAN NYDEGGER, 60 EAST SOUTH TEMPLE, 1000 EAGLE GATE TOWER, SALT LAKE CITY, UT, 84111, US

(73) Assignee: Franken GmbH & Co. KG Fabrik fur Praezisionswerkzeuge, Ruckersdorf (DE)

(21) Appl. No.: 11/760,513

(22) Filed: Jun. 8, 2007

(30) Foreign Application Priority Data
Jun. 9, 2006 (DE) 10 2006 026 853.9

(51) Int. Cl. B23C 5/10

(52) U.S. Cl. 407/54

(57) ABSTRACT

The invention relates to a cutting tool, in particular a milling tool, comprising a basic part and a head part adjoining the basic part and having a circumferential side and an end face, said basic part and head part having a common center axis and said head part comprising at least one lip having a cutting edge on the circumferential side. Said lip having a chip breaker surface adjoining the cutting edge of the circumferential side and comprising two chip breaker surface sections, the first chip breaker surface section being arranged at a first rake angle and the second chip breaker surface section being arranged at a second rake angle, said second rake angle being larger with respect to the first rake angle, and the first chip breaker surface section having an arch.

### CROSS-REFERENCE TO RELATED APPLICATIONS

The present invention claims the benefit of priority under 35 U.S.C. § 119 to German Patent Application No. 10 2006 026 853.9, filed on Jun. 9, 2006, having a translated title of “Cutting Tool,” the entire contents of which are incorporated herein by reference.

### BACKGROUND OF THE INVENTION

1. The Field of the Invention

The invention relates to a cutting tool, in particular a milling tool in the form of an end mill.

2. Background and Relevant Art

As a rule, an end mill has an elongated cylindrical shank as a basic part and a head part which adjoins the basic part and has a circumferential side and an end face. The basic part and the head part are as a rule designed in one piece and have a common center axis. The head part usually comprises a plurality of lips, of which each may have a cutting edge on the circumferential side and a cutting edge on the end face.

Depending on the range of use of an end mill, in particular with regard to the material removal rate which is to be achieved with such an end mill, said end mill is of varying design. For example, end mills having a high material removal rate are required in the aircraft industry during the production of parts of aircraft, since components for aircraft have to be milled in one piece from a solid block of material for safety reasons.

In order to keep the time for the production of such components within limits, material removal rates of 41/min and more are required for end mills used in this sector. These end mills are at the same time subjected to pronounced loads, for which reason in particular the manufacturers of such end mills are always endeavoring to improve the cutting properties of the end mills.

One possibility of reducing the loads acting on a tool during the cutting consists, for example, in influencing the chip flow behavior of tool surfaces.

For example, DE 197 24 319 C1 discloses a method in which, in the region of cutting edges in cutting tools having a geometrically defined lip, the rake faces, at a slight distance from the cutting edge, are provided with a pattern varying the surface structure by means of laser irradiation. The flow velocity and the direction of the chips flowing off can be influenced by this measure.

### BRIEF SUMMARY OF THE INVENTION

Implementations of the present invention relate generally to systems, methods, and apparatus configured for as high a material removal rate as possible.

According to implementations of invention, for example, these and other advantages can be achieved by a cutting tool, in particular a milling tool, that includes a basic part; and a head part adjoining the basic part and having a circumferential side and an end face. In general, the basic part and head part have a common center axis, the head part has at least one lip having a cutting edge on the circumferential side, and the lip has a chip breaker surface adjoining the cutting edge of the circumferential side. In addition, the chip breaker surface comprises two chip breaker surface sections, where the first chip breaker surface section is arranged at a first rake angle and the second chip breaker surface section is arranged at a second rake angle. Furthermore, the second rake angle is larger with respect to the first rake angle, and the first chip breaker surface section has an arch.

According to implementations of the invention, therefore, provision can be made in the cutting tool for the chip breaker surface to be subdivided into two chip breaker surface sections having different rake angles. Owing to the notion that the second rake angle of the second chip breaker surface section is selected to be larger compared with the first rake angle of the first chip breaker surface section, this achieves the effect that first of all only the first chip breaker surface section comes into contact with chips during the cutting operation.

In particular if the first chip breaker surface section has an arch, the first chip breaker surface section serves virtually as a type of “ski-jump hill” for the chips, such that the chips do not reach the second chip breaker surface section until after a flight phase in the chip space. As a result, the cutting pressure is reduced, since lower forming energy for the chips is required. As a consequence of the reduced cutting pressure, a higher material removal rate can be achieved with the cutting tool, as a result of which the use of such a cutting tool becomes more efficient.

According to an embodiment of the invention, the lip has not only a cutting edge on the circumferential side but also a cutting edge on the end face of the head part, the cutting edge of the circumferential side of the lip merging into the cutting edge of the end face of the lip. In this way, the cutting tool can cut not only circumferentially but also at the end face.

According to an embodiment of the invention, the cutting edge of the end face in this case adjoins the second chip breaker surface section. Accordingly, the first chip breaker surface section is assigned essentially only to the cutting edge of the circumferential side, whereas only one chip breaker surface, namely the second chip breaker surface section, is assigned to the cutting edge of the end face.

Variants of the invention provide for the first rake angle to be between 0° and 20°, in particular between 5° and 20°, and preferably 17° and for the second rake angle to be between 10° and 30°, preferably 24°.

According to an embodiment of the invention, the first chip breaker surface section, which is designated as a chip breaker groove as a result of its effect as a “ski-jump hill”, has a width of between 0.2 and 1.5 mm as viewed radially in the direction of the center axis. The second chip breaker surface section may also be arched for improved guidance of the chips.

Further variants of the invention provide for the lip, on the circumferential side, to comprise three flanks, of which each has a clearance angle relative to a cutting plane of the circumferential side. The first clearance angle of the first flank is between 0.8° and 1.2°, preferably 1°, the second clearance angle of the second flank is between 10° and 18°, preferably 12°, and the third clearance angle of the third flank is between 20° and 25°, preferably 23°. During the cutting operation, this configuration having three flanks on the circumferential side results overall in lower friction between the cutting tool and the workpiece, with a damping effect, such that the operation of the cutting tool, which is preferably rotated about the center axis, is smoother and therefore the surfaces produced during the cutting are of better quality.

According to an embodiment of the invention, the width of the first flank on the circumferential side in the circumferential direction is dependent on the overall diameter of the tool, which is of least partly, essentially cylindrical design, the width of the first flank likewise increasing with increasing diameter of the tool. According to a preferred embodiment of the tool, it has a diameter of between 6 mm and 30 mm, in which case the width of the flank can vary between 0.03 mm and 0.16 mm. Parameter ranges for the selectable width of the first flank are respectively assigned in tabular form to various diameters of the tool.

Apart from that, the three flanks of the lip on the circumferential side are of essentially plane design, but may also be slightly concavely curved.

A further configuration of the cutting tool provides for the lip, on the end face, to have two end flanks, of which each encloses an end clearance angle with a cutting plane of the end face. The first end clearance angle of the first end flank is between 7° and 15°, preferably 12°, and the second end clearance angle of the second end flank is between 15° and 30°, preferably 23°.

Apart from that, the cutting edge of the circumferential side of the lip of the cutting tool merges into the cutting edge of the end face of the lip with a radius. The radius in this case is generally between 1.5 mm and 5 mm, preferably 4 mm. As a rule, however, the radius is adapted to the overall diameter of the tool.

According to an embodiment of the invention, not only does the cutting edge of the circumferential side of the lip merge into the cutting edge of the end face with the radius, but the flanks of the circumferential side also merge into the flanks of the end face. Whereas the second flank of the circumferential side merges into the first end flank and the third flank of the circumferential side merges into the second end flank, the first flank of the circumferential side of the lip runs out in the radius, preferably after essentially two thirds of the radius.

According to a variant of the invention, the cutting tool has a plurality of lips of essentially identical design, but preferably four, five or six lips, which are arranged about the center axis. The cutting edges on the circumferential side of the lips in this case lie essentially on a lateral surface of a cylinder.

According to a preferred embodiment of the invention, the lips are arranged relative to one another at at least two different pitch angles with respect to the center axis. The lips are therefore not arranged uniformly about the center axis. The pitch angles between successive lips are between 60° and 120°. Embodiments of the cutting tool provide for it to have four lips, the pitch angle between the first and the second lip and between the third and the fourth lip being 80° in each case and the pitch angle between the second and the third lip and between the fourth and the first lip being 100° in each case. However, the pitch angle between the first and the second lip and between the third and the fourth lip may also be 60° in each case and the pitch angle between the second and the third lip and between the fourth and the first lip may also be 120° in each case.

According to an embodiment of the invention, the cutting edge of the circumferential side of a lip runs helically, in which case the helix angle of a lip may be constant and is in particular between 20° and 50°, preferably 30°. However, the helix need not necessarily be constant, but rather may increase axially in the direction of the center axis M towards the end face. The helix angle may therefore increase with respect to the center axis towards the end face, in particular from a helix angle of 0° to 25° at a region of the lip that is remote from the end face up to a helix angle of between 30° and 50° at the end face.

A chip space for the removal of chips is assigned to each lip of the cutting tool, the volume of the chip space, according to an embodiment of the invention, decreasing axially in the direction of the center axis towards the basic part. According to a variant of the invention, the chip space is of essentially conical design, the cone having an angle with respect to the center axis ranging from greater than 0° up to 10°, preferably between 5° and 6°. If the cutting edge of the circumferential side of a lip runs helically, the conically designed chip space accordingly also runs helically, the volume of the chip space decreasing axially in the direction of the center axis towards the basic part as a result of the conical configuration of the chip space, as already mentioned.

In a preferred variant of the invention, a chip space for the removal of chips is assigned to at least one lip or each lip, the tool having a low surface roughness at least in sections of the surface of the at least one chip space, which sections can come into contact with the removed chips, the average surface roughness (the arithmetical mean) Ra being selected between 0.03 μm and 0.10 μm and/or the averaged peak-to-valley height (ten point height) Rz being selected between 0.10 μm and 0.35 μm and/or the maximum peak-to-valley height Rmax being selected between 0.20 μm and 0.50 μm.

This low surface roughness or smoother surface is preferably produced by the surface or the corresponding sections of the surface in the chip space having the low surface roughness being produced by grinding or polishing or regrinding or repolishing using a correspondingly fine grinding tool. Thus only the corresponding surfaces in the chip spaces or flutes are reworked for additional smoothing; on the other hand, the other regions of the tool, such as in particular the lips, are not reworked. The smoother or reworked surface regions in the chip space preferably lie in a surface region in the chip space that is opposite the rake face or, in other words, on a back of a lip, said back facing the chip space of an adjacent lip.

The cutting edge of at least one lip, preferably each lip, is at least partly wavy or wavelike or has a roughing tooth system. In this embodiment, which is provided for roughing, the design of the chip breaker surface having the two chip breaker surface sections also additionally serves to stabilize the roughing tooth system or wavy lip.

According to a configuration of the invention, two respective cutting regions having a respective cutting edge of a lip lie on the end face on a straight line, two cutting regions which lie on a first straight line merging into one another, and two cutting regions which lie on a second straight line intersecting the first straight line having, in the region of the center axis, a respective recess which runs radially outwards in the direction of the first straight line and merges into a respective chip space. Such a recess has two essentially V-shaped sections. There are therefore two such recesses having two essentially V-shaped respective sections in a tool having four lips.

According to a variant of the invention, the tool has at least one passage for feeding coolant to the lips, the passage having its orifice in the region of a recess and of a second end flank of a lip, whose cutting region on the end face does not merge into another cutting region. The tool having four lips preferably has two passages, the orifices of which are 180° opposite one another. This arrangement of the orifices of the cooling passages enables coolant to be readily admitted to the lips via the recesses. In addition, good removal of collecting chips is effected.

According to a variant of the invention, the cutting tool is preferably a torus cutter.

The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 shows an end mill in a perspective illustration;

FIG. 2 shows a cross section through the end mill from FIG. 1;

FIG. 3 shows a lip according to the illustration according to FIG. 2 in an enlarged view;

FIG. 4 shows a perspective view of the head part of the end mill in FIG. 1; and

FIG. 5 shows a plan view of the end face of the end mill from FIG. 1.

Additional features and advantages of exemplary implementations of the invention will be set forth in the description which follows, and in part will be obvious from the description, or may be learned by the practice of such exemplary implementations.

### DETAILED DESCRIPTION OF THE PREFERRED EMBODIMENTS

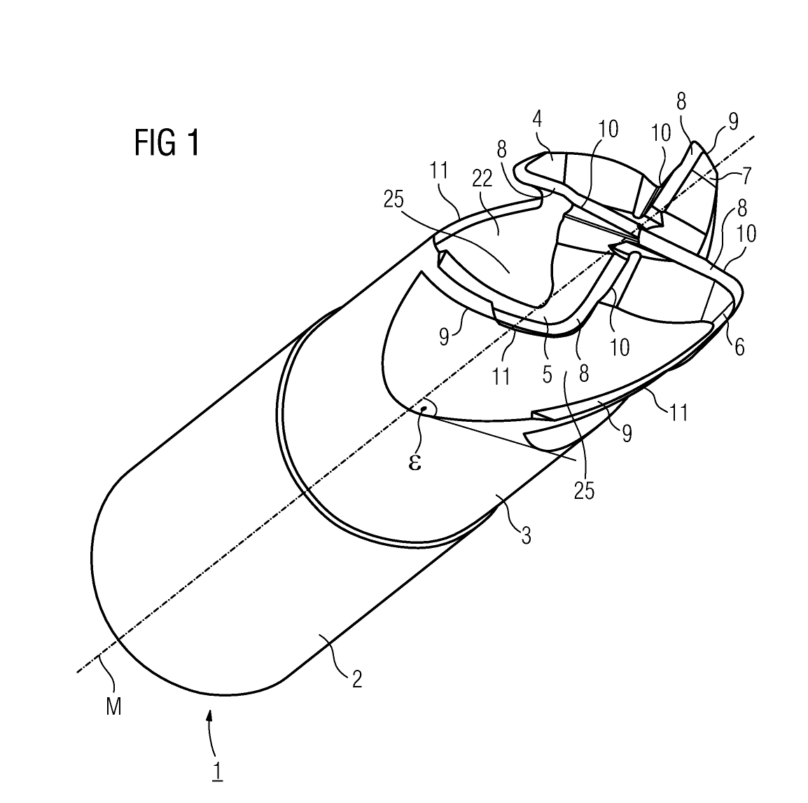

A cutting tool in the form of an end mill, in the present case in the form of a torus cutter 1, is shown in FIG. 1. The torus cutter 1 comprises a basic part 2 which constitutes the shank of the torus cutter 1. Adjoining the shank 2 is a head part 3 of the torus cutter 1, which head part 3 has the lips of the torus cutter.

In the present case, the torus cutter 1 is of at least partly, essentially cylindrical design and has a center axis M, about which the torus cutter 1 can be rotated. In the case of the present exemplary embodiment, the torus cutter 1 has four lips 4 to 7, which are arranged around the center axis M. Each of the lips 4 to 7 has a cutting region 8 on the end face and a cutting region 9 on the circumferential side. Each of the lips 4 to 7 has a cutting edge 10 in its cutting region 8 on the end face and a cutting edge 11 in its cutting region 9 on the circumferential side.

In the case of the present exemplary embodiment, the cutting regions 9 on the circumferential side, in particular the cutting edges 11 of the circumferential side of the lips 4 to 7, run helically, the cutting edges 11 being located essentially on the lateral surface of the cylindrical torus cutter 1. The helix angle ε of each lip 4 to 7, said helix angle ε being specified with respect to the center axis M, a factor which is illustrated in FIG. 1, is 30° in the present exemplary embodiment. However, depending on the dimensioning of the torus cutter, the helix angle may be between 20° and 50°. The helix of a lip 4 to 7 preferably does not change, as in the case of the present exemplary embodiment. However, the helix may also be increased axially in the direction of the center axis M towards the end face of the torus cutter 1.

In the case of the present exemplary embodiment, the lips 4 to 7 arranged about the center axis M are arranged non-uniformly about the center axis M, i.e. in each case with the same spacing angle with regard to the center axis M.

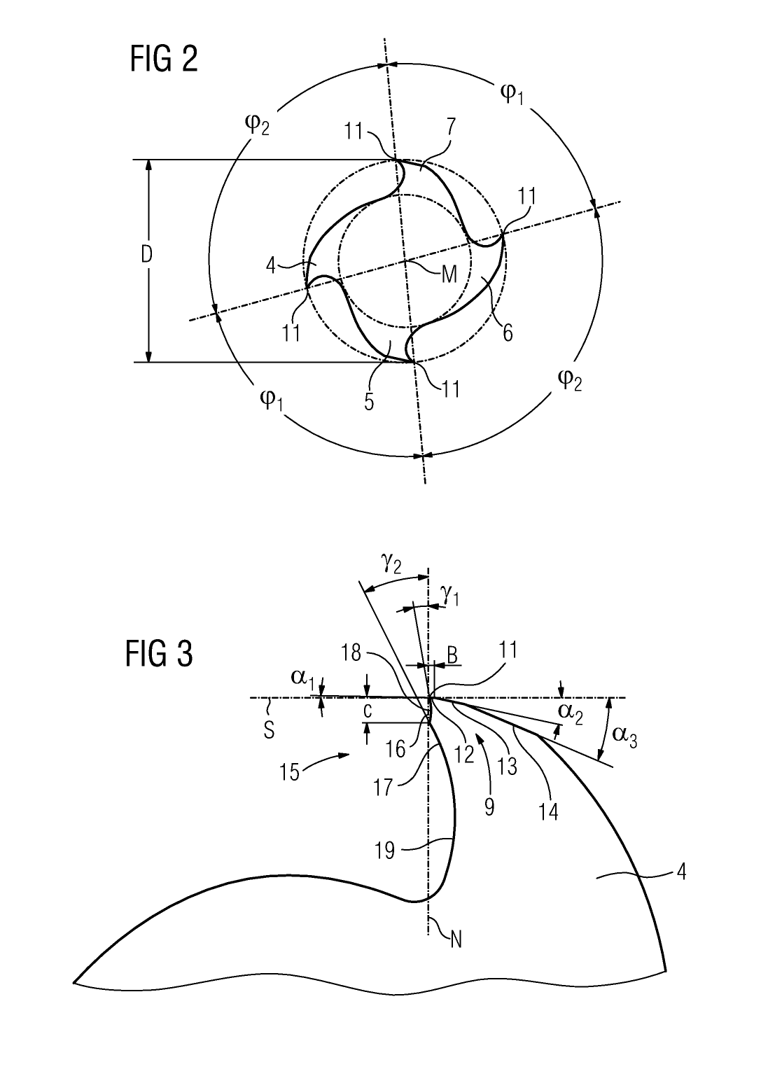

As can be seen in particular from FIG. 2, which in a simplified manner shows a cross section through the head part 3 of the torus cutter 1 in the region of the lips 4 to 7, the angle between the lips 4 to 7 varies, reference being made to the respective position of the cutting edge, in the case of FIG. 2 to the position of the cutting edge 11 of the circumferential side of a lip 4 to 7. Whereas the “pitch angle” between the cutting edge 11 of the circumferential side of the lip 4 and the cutting edge 11 of the circumferential side of the lip 5 and also between the cutting edge 11 of the circumferential side of the lip 6 and the cutting edge 11 of the circumferential side of the lip 7 is in each case φ₁, the cutting edge 11 of the circumferential side of the lip 5 and the cutting edge 11 of the circumferential side of the lip 6 and also the cutting edge 11 of the circumferential side of the lip 7 and the cutting edge 11 of the circumferential side of lip 4 enclose a respective pitch angle φ₂.

In the case of the present exemplary embodiment, the pitch angle φ₁ is 80° and the pitch angle φ₂ is 100°. However, the pitch angles φ₁ and φ₂ may also assume other values. For example, the pitch angle φ₁ may be 60° and the pitch angle φ₂ may be 120°. It is worth mentioning that the angles φ₁ and φ₂ lie relatively far apart. The pitch angle between two successive lips is preferably between 60° and 120°. In the case of the present exemplary embodiment, the specification of the pitch angles otherwise also applies to the corresponding cutting edges 10, belonging to the cutting edges 11 of the circumferential side, of the end face of the respective lip, as can be seen from FIG. 5.

In particular the geometrical relationships of a lip in the circumferential direction are to be explained with reference to FIG. 3, which shows a lip from FIG. 2 in an enlarged illustration. In the case of the present exemplary embodiment, the lip 4 is shown enlarged on its circumferential side in FIG. 3 by way of example for all lips of the torus cutter 1. In the cutting region 9 on the circumferential side, the lip 4 has the cutting edge 11 of the circumferential side. Directly adjacent to the cutting edge 11 is a first flank 12, which is arranged at a first clearance angle relative to the cutting plane designated by S. The cutting plane S is the tangential plane to the cutting edge 11 in the cutting direction. The first clearance angle α₁ of the first flank 12 is between 0.8° and 1.2°, preferably 1°.

Adjoining the first flank 12 is a second flank 13, which is arranged at a second clearance angle α₂, measured relative to the cutting plane S. The second clearance angle α₂ of the second flank 13 is between 10° and 18°, preferably 12°. Finally, adjoining the second flank 13 is a third flank 14, which is arranged at a third clearance angle α₃, which is likewise measured relative to the cutting plane S. The third clearance angle α₃ of the third flank 14 is between 20° and 25°, preferably 23°. The width B of the first flank 12 in the circumferential direction, said width B also being designated as supporting bevel, depends on the diameter D of the cylindrical torus cutter 1.

With increasing diameter D of the torus cutter 1, the width B of the first flank 12 also increases. The torus cutter is preferably designed with a diameter D of between 6 mm and 30 mm, in which case the width B of the first flank 12 in the circumferential direction can, in this case, vary between 0.03 mm and 0.16 mm. In the case of the present exemplary embodiment, the three flanks 12 to 14 are shown as plane flanks. However, the three flanks need not necessarily be plane, but rather may also be slightly curved; in particular, the three flanks may be designed to be curved slightly concavely.

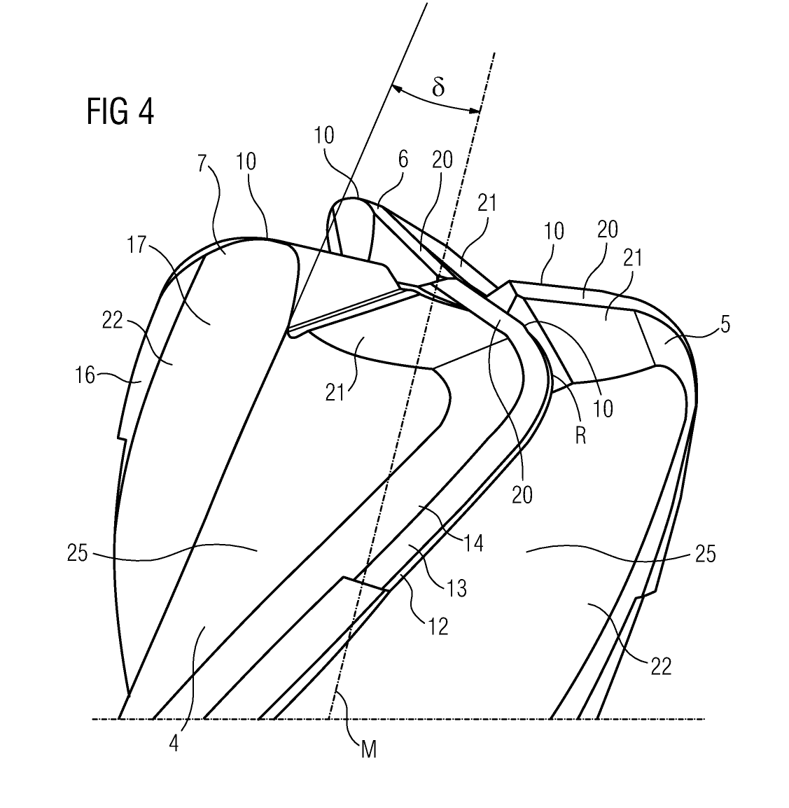

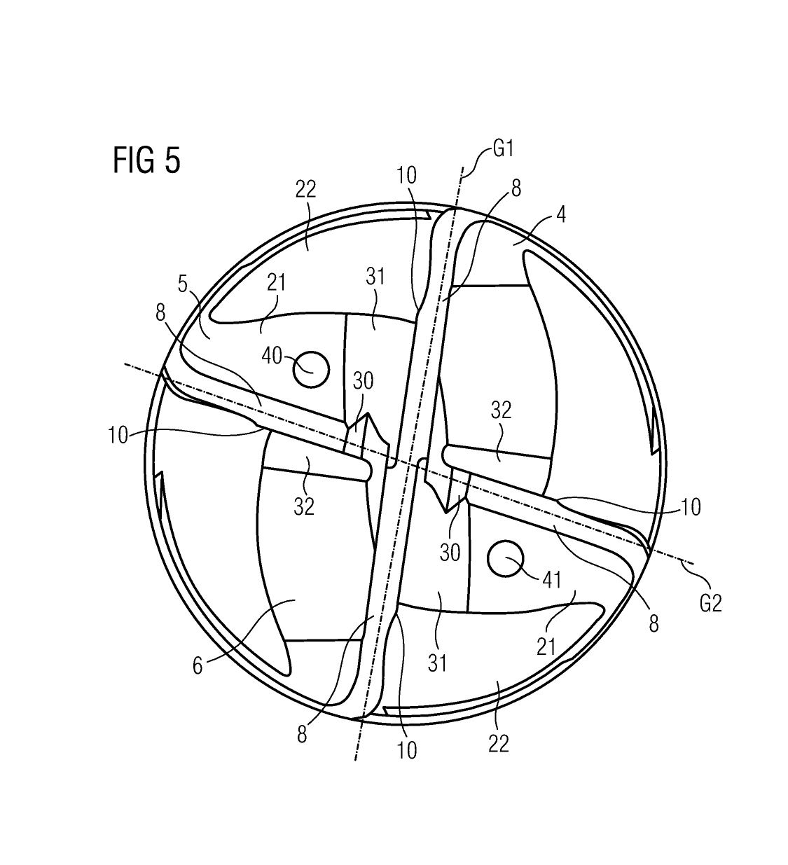

The three flanks 12 to 14 of the lip 4, by way of example for all the lips 4 to 7, are shown again in FIG. 4, which shows a perspective view of the lips 4 to 7 of the head part 3 of the torus cutter 1.

As can also be seen from FIG. 3, the cutting region 9, in the circumferential direction of the lip 4, has a chip breaker surface 15 which comprises two chip breaker surface sections 16 and 17. The first chip breaker surface section 16 is arranged at a first rake angle γ₁ with respect to a normal plane N, running through the cutting edge 11, relative to the cutting plane S and the second chip breaker surface section 17 is arranged at a second rake angle 72 with respect to the normal plane N. The first rake angle γ₁, which is specified with respect to the initial course, adjacent to the cutting edge 11, of the first chip breaker surface section 16, is between 5° and 20°, preferably 17°.

The second rake angle γ₂, which is specified with respect to the initial course, adjacent to the first chip breaker surface section 16, of the second chip breaker surface section 17, is between 10° and 30°, preferably 24°. Depending on the embodiment of the torus cutter 1, the second rake angle γ₂ is always selected to be greater than the first rake angle γ₁, since, as can be seen from FIG. 3, this results in a type of “ski-jump hill” for chips produced during the cutting process and sliding along the chip breaker surface section 16. To intensify this effect, the first chip breaker surface section 16 has an arch 18. In the case of the present exemplary embodiment, the chip breaker surface section 17 otherwise also has an arch 19.

Due to the embodiment in particular of the chip breaker surface section 16, which is also designated as chip breaker groove, chips produced during the cutting process as a rule first of all come into contact only with the first chip breaker surface section 16 and are first of all kept away from the second chip breaker surface section 17 in particular due to the arch 18 and the angle selection of γ₁ and γ₂. However, this does not rule out the possibility of chips nonetheless coming into contact with the second chip breaker surface section 17 just after they have been formed. An advantage with this design is that the cutting pressure is reduced during the cutting operation, since less energy is required for the forming of the chips.

Apart from that, the chip breaker surface section 16 has a width C of between 0.2 and 1.5 mm radially in the direction of the center axis M.

As can be seen in particular from FIGS. 1 and 4, each cutting region 9 of a circumferential side of one of the lips 4 to 7 merges into the respective cutting region 8 of the end face of the lip 4 to 7. In particular, the cutting edge 11 of the circumferential side of a lip 4 to 7 merges into the cutting edge 10 of the end face of the lip 4 to 7. As illustrated with reference numerals with reference to FIG. 4, each of the lips 4 to 7, in its cutting region 8 on the end face, has in addition to the cutting edge 10 a first end flank 20 and a second end flank 21. The first end flank 20 adjoins the respective cutting edge 10 of the end face and has a first end clearance angle β₁ between 7° and 15°, preferably 12°, with respect to an end-face cutting plane (not explicitly shown).

The second end flank 21 adjoining the first end flank 20 encloses a second end clearance angle β₂ between 15° and 30°, preferably 23°, with the end-face cutting plane (not explicitly shown).

As already mentioned, the cutting region 9 of the circumferential side merges into a cutting region 8 of the end face, in particular with a radius R. This specifically applies to the cutting edge 11 of the circumferential side and the cutting edge 10 of the end face. The radius R is as a rule between 1.5 mm and 5 mm, preferably 4 mm. As can be seen in particular from FIG. 4, the first flank 12 on the circumferential side of each lip 4 to 7 runs out in the radius R, preferably after essentially two thirds of the radius R. Accordingly, the second flank 13 of the circumferential side merges essentially into the first end flank 20 of the end face of a lip 4 to 7. In a corresponding manner, the third flank 14 of the circumferential side merges into the second end flank 21 of the end face.

As can likewise be seen from FIG. 4 with reference to the lip 7, by way of example for all lips 4 to 7, the first chip breaker surface section 16 is only present on the circumferential side and not on the end face of each of the respective lips 4 to 7. The cutting edge 10 on the end face of each lip 4 to 7 directly adjoins only the second chip breaker surface section 17.

In addition, each of the lips 4 to 7 has a chip space 22 for the removal of the chips produced during the cutting. In this case, the volume of each chip space 22 decreases preferably axially in the direction of the center axis M towards the shank 2. Preferably, each chip space 22 of the lips 4 to 7 is of essentially conical design, the cone having an angle δ ranging from greater than 0° up to 10°, preferably between 5° and 6°, with respect to the center axis M, as a result of which the reduction in the volume of the chip space 22 is achieved. Due to the reduction in size of the chip space 22, the construction of the torus cutter 1 in the head region 3, specifically in the region of its lips 4 to 7, becomes more robust in the direction of the center axis M towards the shank 2, such that axial distortions during the cutting can be reduced.

The surface in each chip space 22, in a section which is designated by 25 in FIGS. 1 and 4 and is opposite the chip breaker surface 15, 16, 17 and its associated cutting edge 11 or faces said chip breaker surface 15, 16, 17 and said cutting edge 11 from the other side of the chip space 22, is now smoothed by repolishing or regrinding in such a way that lower surface roughness is present there than in the rest of the chip space 22. The average surface roughness (the arithmetical average) Ra in these sections 25 of the surface in the chip spaces 22 is set between 0.03 μm and 0.10 μm and/or the averaged peak-to-valley height (ten point height) Rz is set between 0.10 μm and 0.35 μm and/or the maximum peak-to-valley height Rmax is set between 0.20 μm and 0.50 μm. This measure improves the removal of chips in the chip spaces 22 and reduces the frictional forces occurring in the process.

The end-face configuration of the torus cutter 1 is shown in FIG. 5 in a plan view of the torus cutter 1. Thus, it can be seen from FIG. 5 that two respective cutting regions 8 having a respective end-face cutting edge 10 of a lip lie on the end face on a straight line G1 and G2, respectively. In the case of the present exemplary embodiment, the cutting regions 8 of the end face of the lips 4 and 6 lie on the straight line G1 and merge into one another. The cutting regions 8 of the lips 5 and 7 lie on the straight line G2, which intersects the straight line G1, the cutting region 8 on the end face of the lip 5 not merging into the cutting region 8 on the end face of the lip 7.

On the contrary, the cutting regions 8 of the lips 5 and 7 have uniform recesses running in the direction of the straight line G1, each recess comprising two essentially V-shaped sections 30 and 31. In this case, the sections 30, 31 of the recess merge into a respective chip space 22. A likewise V-shaped region 32 branches off from the section 30 in each case in the direction of the straight line G2 at the lips 4 and 6, said regions 32 likewise opening into a respective chip space 22.

As can be seen only from FIG. 5 for reasons of clarity, the torus cutter 1 has two passages 40 and 41 for feeding coolant to the lips 4 to 7, the passage 40 having its orifice in the region of the section 31 and of the second end flank 21 of the lip 5, and the passage 41 having its orifice in the section 31 of the recess of the lip 7 and of the second end flank 21 of the lip 7. The coolant for cooling the lips 4 to 7 during the cutting process can pass through the recesses 30 to 32 to the respective lips 4 to 7 and in addition provide for removal of the chips collecting during the cutting operation. What is more, the orifices of the passages 40 and 41 are 180° opposite one another. The directing of the passages 40, 41 through the torus cutter 1 is not explicitly shown, but is preferably effected correspondingly helically specifically in the head region 3 in adaptation to the helical directing of the lips 4 to 7.

The invention has been described above using a torus cutter as an example. However, the invention is not restricted to a torus cutter or another milling tool. On the contrary, other cutting tools may also be designed according to the invention.

Apart from that, said dimensional and angle specifications are to be understood only by way of example, i.e. other dimensions and angles and also tolerances not explicitly specified are possible without departing from the invention.

The cutting tool in this case is described with four lips, which, however, is not absolutely necessary. Thus the tool may also be designed with five, six or more lips. The lips at the same time need not necessarily also have end-face cutting edges. On the contrary, cutting edges may be provided only on the circumferential side.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

### LIST OF DESIGNATIONS

1 Torus cutter

2 Shank

3 Head part

4 to 7 Lips

8 End-face cutting region

9 Circumferential cutting region

10 Cutting edge of the end face

11 Cutting edge of the circumferential side

12 First flank (supporting bevel)

13 Second flank

14 Third flank

15 Chip breaker surface

16 First chip breaker surface section (chip breaker groove)

17 Second chip breaker surface section

18 Arch

19 Arch

20 First end flank

21 Second end flank

22 Chip space

25 Section

30 Section of the recess

31 Section of the recess

32 Recess

40, 41 Coolant passage

M Center axis

ε Helix angle

D Tool diameter

α₁ First clearance angle

α₂ Second clearance angle

α₃ Third clearance angle

β₁ First end clearance angle

β₂ Second end clearance angle

γ₁ First rake angle

γ₂ Second rake angle

φ₁ First pitch angle

φ₂ Second pitch angle

δCone angle

S Cutting plane

N Normal plane

B Width of the first flank

C Width of the first chip breaker surface section

R Radius

G1 First straight line

G2 Second straight line

1-20. (canceled)

21. A cutting tool, in particular a milling tool, comprising:
a basic part; and
a head part adjoining the basic part, the head part further having a circumferential side and an end face;
wherein:
the basic part and head part having a common center axis;
the head part has at least one lip having a cutting edge on the circumferential side;
the at least one lip has a chip breaker surface adjoining the cutting edge of the circumferential side;
the chip breaker surface comprises two chip breaker surface sections;
the first chip breaker surface section is arranged at a first rake angle, the second chip breaker surface section is arranged at a second rake angle, the second rake angle is larger with respect to the first rake angle, and the first chip breaker surface section comprises an arch.

22. The cutting tool as claimed in claim 21, wherein at least one of:
the lip has a cutting edge on the end face;
the cutting edge of the circumferential side of the lip preferably merges into the cutting edge of the end face of the lip; or
the cutting edge of the end face adjoins the second chip breaker surface section.

23. The cutting tool as claimed in claim 22, wherein at least one of:
the cutting edge of the circumferential side of the lip merges into the cutting edge of the end face of the lip with a radius R, the radius R being between about 1.5 mm and 5 mm; or
the first flank on the circumferential side of the lip runs out in the radius R.

24. The cutting tool as claimed in claim 21, wherein the first rake angle is selected from one of:
a range of between about 0° and 20°;
a range of between about 5° and 20°; or about 17°.

25. The cutting tool as claimed in claim 21, wherein the second rake angle is selected from one of:
between one of about 10° and 30°; or about 24°.

26. The cutting tool as claimed in claim 21, wherein the first chip breaker surface section has a width C of between about 0.2 and 1.5 mm radially in the direction of the center axis M.

27. The cutting tool as claimed in claim 21, wherein the second chip breaker surface section comprises an arch.

28. The cutting tool as claimed in claim 21, wherein at least one of:
the lip, on the circumferential side, comprises three flanks, of which each has a clearance angle relative to a cutting plane S of the circumferential side;
the first clearance angle of the first flank is between a range of about 0.80 and 1.2°;
the second clearance angle of the second flank is between a range of about 10° and 18°0;
the third clearance angle of the third flank is between a range of about 20° and 25°;
the width B of the first flank in the circumferential direction is dependent on the diameter D of the tool and increasing with increasing diameter D of the tool, the diameter D of the tool is between about 6 mm and 30 mm and the width B of the first flank is between about 0.03 mm and 0.16 mm; or
the three flanks preferably are one of essentially plane design or of slightly concavely curved design.

29. The cutting tool as recited in claim 21, wherein at least one of:
the lip, on the end face, has two end flanks, of which each has an end clearance angle relative to a cutting plane of the end face, the first end clearance angle of the first end flank being between 7 about ° and 15°; or
the second end clearance angle of the second end flank is between about 15° and 30°.

30. The cutting tool as claimed in claim 21, wherein the cutting tool has a plurality of lips of essentially identical design, which are arranged about the center axis.

31. The cutting tool as claimed in claim 21, wherein the cutting edge on the circumferential side of the lip lies essentially on a lateral surface of a cylinder.

32. The cutting tool as claimed in claim 21, wherein at least one of:
a plurality of lips are provided and arranged relative to one another at at least two different pitch angles with respect to the center axis, the pitch angle between two successive lips being between about 60° and 120°;
the cutting tool in particular has four lips;
the pitch angle between the first and the second lip, and between the third and the fourth lip, is about 80° in each case; and the pitch angle between the second and the third lip, and between the fourth and the first lip is about 100° in each case; or
the pitch angle between the first and the second lip, and between the third and the fourth lip, is about 60° in each case; and the pitch angle between the second and the third lip, and between the fourth and the first lip, is about 120° in each case.

33. The cutting tool as claimed in claim 21, wherein the cutting edge of the circumferential side of a lip runs helically.

34. The cutting tool as claimed in claim 33, wherein at least one of:
the helix angle of a lip is between about 20° and 50°, preferably 30°; or
the helix angle of the lip increases axially in the direction of the center axis towards the end face, and from a helix angle of about 0° to 25° at a region of the lip that is remote from the end face up to a helix angle of between about 30° and 45° at the end face.

35. The cutting tool as claimed in claim 21, wherein at least one of:
a chip space for the removal of chips is assigned to the lip, the volume of the chip space decreasing axially in the direction of the center axis towards the basic part; or
the chip space being of essentially conical design, the cone having an angle with respect to the center axis ranging from greater than about 0° up to about 10°.

36. The cutting tool according as claimed in claim 21, wherein:
two respective cutting regions have a respective cutting edge of a lip lie on the end face on a straight line;
two cutting regions, which lie on a first straight line, merge into one another; and
two cutting regions, which lie on a second straight line, intersect the first straight line having, in the region of the center axis, a respective recess which runs radially outwards in the direction of the first straight line and merges into a respective chip space, the recess having two essentially V-shaped sections.

37. The cutting tool as claimed in claim 36, wherein the cutting tool has at least one passage for feeding coolant to the lips, the passage having its orifice in the region of a recess and of a second end flank of a lip, whose cutting region on the end face does not merge into another cutting region, two passages being provided, the orifices of which are 180° opposite one another.

38. The cutting tool as claimed in claim 21, wherein the cutting tool is a torus cutter.

39. The cutting tool as claimed in claim 21, wherein at least one cutting edge of at least one lip has at least one of:
a wavy shape;
a toothed shape; or
a roughing tooth system.

40. The cutting tool as claimed in claim 21, wherein at least one of:
a chip space for the removal of chips is assigned to at least one lip;
the cutting tool has a low surface roughness at least in a section of the surface of the at least one chip space; or
the section of the surface of the at least one chip space at least one of:
can come into contact with the removed chips;
opposes a chip breaker surface in the chip space; or
is arranged on a back of a lip.

41. The cutting tool as claimed in claim 40, wherein:
the back faces the chip space of an adjacent lip; and
at least one of:
the average surface roughness Ra is selected between about 0.03 μm and 0.10 μm;
the averaged peak-to-valley height Rz is between about 0.10 μm and 0.35 μm; or
the maximum peak-to-valley height Rmax is between about 0.20 μm and 0.50 μm; and
the surface or each section of the surface in the chip space has a low surface roughness produced by grinding, polishing, regrinding, or repolishing using a correspondingly fine grinding or polishing tool.
